(19) United States
(12) Patent Application Publication
(10) Pub. No.: US 2013/0219721 A1
(43) Pub. Date: Aug. 29, 2013

(54) Razor Assembly

(71) Applicants: John Coleman, Philadelphia, PA (US); Siddharth Gulati, Raritan, NJ (US); David Noble, Wallingford, CT (US); Andrew Pennella, Milford, CT (US); David Schiff, Highland Park, NJ (US)

(72) Inventors: John Coleman, Philadelphia, PA (US); Siddharth Gulati, Raritan, NJ (US); David Noble, Wallingford, CT (US); Andrew Pennella, Milford, CT (US); David Schiff, Highland Park, NJ (US)

(73) Assignee: Eveready Battery Company Inc., St Louis, MO (US)

(21) Appl. No.: 13/716,441

(22) Filed: Dec. 17, 2012

Related U.S. Application Data
(60) Provisional application No. 61/578,336, filed on Dec. 21, 2011.

(51) Int. Cl. B26B 21/44

(52) U.S. Cl. CPC B26B 21/446
USPC 30/41

(57) ABSTRACT

A safety razor adapted to deliver a non-solid shaving aid material during normal use includes a handle, a razor cartridge and a reservoir for the shaving aid material in fluid communication with an applicator of the razor cartridge. A linkage extends from the reservoir to the razor cartridge. Pivotal movement of the razor cartridge away from its at-rest position causes the linkage to move relative to both the razor cartridge and the reservoir and in particular away from the reservoir. A plug of the linkage is removed from a vent aperture of the reservoir providing pressure relief for any partial vacuum caused from dispensing a portion of the shaving aid material. In the at-rest position the plug seals the vent and helps alleviate unwanted drooling of the shaving aid material when the safety razor is not in use.

### CROSS REFERENCE TO RELATED APPLICATIONS

This application claims the benefit of U.S. Provisional Patent Application Ser. No. 61/578,336, filed December 21, the content of which is incorporated herein in its entirety for reference.

### BACKGROUND

1. Field of the Present Disclosure

The present disclosure is generally directed to shaving implements, specifically safety razors, wherein the safety razor stores and dispenses non-solid shaving aid material(s) during use.

2. Background

Many modern safety razors include a disposable razor cartridge adapted to be selectively connected to a reusable handle by cartridge support structure therebetween. The cartridge includes a housing having a plurality of razor blades each having a sharpened cutting edge disposed therein. Other modern safety razors have a handle and a razor cartridge that are intended to be permanently coupled and disposed of as a single unit.

There have been many proposals to provide a safety razor having a razor cartridge in fluid communication with a reservoir adapted to store a non-solid shaving aid material. However, such razors have not been successfully commercialized or at least not manufactured on a scale that is significant in a mass market such as that of safety razors.

Several difficulties arise when trying to provide a safety razor that stores and dispenses non-solid shaving aid material in a manner that meets consumer expectations. These difficulties include providing suitable valving to ensure that the flow of shaving aid material is reliably interrupted during periods of non-use to prevent the shaving aid material undesirably drooling from the razor onto e.g. a bathroom counter surface. Other difficulties include reliably ensuring a desirable flow rate of shaving aid material is provided as the reservoir empties.

### SUMMARY

The present disclosure has for its objective to eliminate, or at least substantially alleviate the limitations of the prior art safety razors. The present disclosure in one aspect is directed safety razor having a handle pivotally supporting a razor cartridge and a reservoir adapted to contain a portion of a non-solid shaving aid material. The razor cartridge can pivot away from an at-rest position relative to the handle in response to forces encountered during normal use of the safety razor against forces provided by a biasing member provided to bias the cartridge towards the at-rest position. The reservoir includes at least one port providing fluid communication between the reservoir and an applicator of the razor cartridge provided to contact the user's skin surface during normal use of the safety razor and deposit shaving aid material thereon. The port can be closed when the razor cartridge is in the at-rest position. The razor cartridge is also pivotally coupled to the reservoir. A linkage extends between the razor cartridge and the reservoir. The linkage has a plug arranged to block a vent of the reservoir when the razor cartridge is in its at-rest position. When the razor cartridge pivots away from the at-rest position in response to forces encountered during normal use of the safety razor, pivotal movement of the razor cartridge relative to the reservoir causes further movement of the linkage relative to both the razor cartridge and the reservoir and causes the plug to be at least partially removed from the vent. Pivotal movement of the razor cartridge relative to the reservoir can also open the port.

Between periods of use the forces provided by the biasing member will urge the razor cartridge to its at-rest position. The plug of the linkage will block or otherwise seal the vent of the reservoir. Unwanted flow of the shaving aid material out of the reservoir through the port and applicator onto e.g. a bathroom counter surface is resisted as the plug seals the reservoir and any such flow would create a partial vacuum in the reservoir in turn resisting such flow. During use of the safety razor the shaving aid material will be deposited on the skin surface of the user from the applicator. The shaving aid material will flow from the reservoir to the applicator. This can in turn create a partial vacuum in the reservoir which can throttle the flow of shaving aid material. However during normal use of the safety razor the razor cartridge can pivot away from its at-rest position in response to forces encountered. The plug will be at least partially removed from the vent relieving any such partial vacuum in the reservoir to ensure the flow rate of the shaving aid material is not thereby throttled.

These and other features and will be more fully understood with reference to the following detailed description when taken in conjunction with the accompanying drawings.

### BRIEF DESCRIPTION OF THE DRAWINGS

FIG. 1 is sectional view of an embodiment of the present disclosure with a razor cartridge in its at-rest position.

FIG. 2 is sectional view of an embodiment of the present disclosure with the razor cartridge in a position away from its at-rest position.

FIG. 3 is sectional view of another embodiment of the present disclosure with a razor cartridge in its at-rest position.

FIG. 3A is an enlarged view of a portion of FIG. 3.

### DETAILED DESCRIPTION

Referring now to the drawings and in particular FIG. 1, a portion of an exemplary safety razor 10 is depicted in a sectional view. The safety razor 10 includes a handle 12, a reservoir 14 and a razor cartridge 16 pivotally mounted on the handle 12. In FIG. 1 the razor cartridge 16 is depicted in an at-rest position relative to the handle 12, i.e. in a position the razor cartridge would adopt between periods of use. For convenience of depiction only a portion of the razor handle 12 is depicted in FIGS. 1-3. One of skill in the art will understand that the handle can extend beyond hypothetical break line 12′ to provide a more convenient hand gripping portion that can be styled and/or provided with elastomeric gripping portions accordingly.

The razor cartridge 16 includes one or more razor blades 22 mounted in a housing 20 having cam surface 26. The razor cartridge also includes an applicator 24 provided to apply a non-solid shaving aid material, as will be described later in the present disclosure, to the skin surface of a user during a normal shaving operation. The applicator can comprise for example a wick or a manifold having an array of apertures as disclosed in U.S. Pat. No. 5,134,775 incorporated herein for reference for essential disclosure relating to elements and features for the application of a non-solid shaving aid material. The applicator can also comprise for example a wick overlying a storage medium as disclosed in U.S. Pat. No. 6,886,254 incorporated herein for reference for essential disclosure relating to elements and features for the application of a non-solid shaving aid material. The applicator can further also comprise for example an array of valves or an array of rollers disclosed in U.S. Pat. No. 7,043,841 and U.S. Patent application 2005/138814 respectively, both incorporated herein for reference for essential disclosure relating to elements and features for the application of a non-solid shaving aid material. Most preferably, when the non-solid shaving aid material comprises liquid oil as will be further defined later in the present disclosure, the applicator comprises a hydrophobic non-woven material layer over an oleophilic fibre pad as disclosed in our concurrently filed patent application having Attorney Docket number SWS-1004, having Ser. No. 61/578,333, incorporated herein for reference in its entirety.

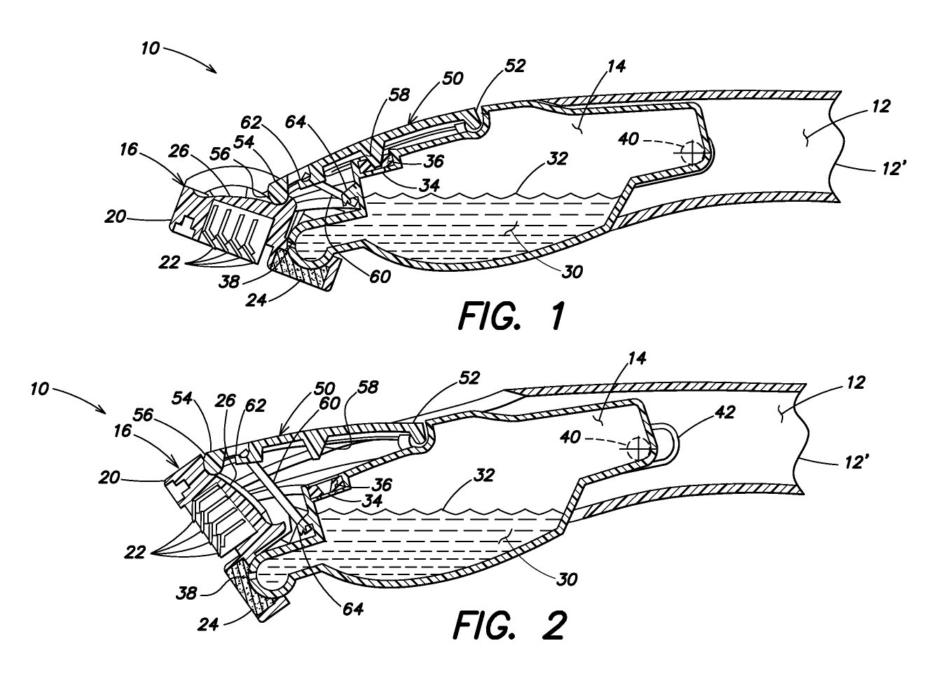

In use of the safety razor, reservoir 14 contains a portion of a non-solid shaving aid material 30, preferably comprising a liquid oil having a kinematic viscosity in the range about 20 cSt to about 40 cSt. The non-solid shaving aid material defines a level 32 in the reservoir. An aperture forming a vent 34 extends through the wall of the reservoir in a region away from the shaving aid material. Preferably the vent includes an elastomeric seal 36 disposed around the periphery of the vent. The reservoir also includes one or more ports 38 included to provide fluid communication between the reservoir and razor cartridge to permit the flow of shaving aid material to the applicator. Preferably, as depicted in FIG. 1, when the razor cartridge is in its at-rest position relative to the reservoir the port is at least partially closed by a portion 21 of the cartridge housing 20. Referring now to FIG. 2, when the razor cartridge pivots away from its at-rest position under the influence of the forces encountered during normal use the port is opened to permit flow of the shaving aid material to the applicator during normal use of the razor.

The reservoir 14 can be fixedly mounted in the handle 12 or, preferably, as depicted in the figures, is slidable along the handle. In this regard the reservoir can include a guide pin 40 (shown in hidden detail as this extends externally to the reservoir and not seen in a sectional view). Guide pin 40 is disposed in, and slides along slot 42 of the handle. In this manner the razor cartridge is pivotal relative to the handle and in response thereto the reservoir pivots relative to the razor cartridge.

A linkage 50 is disposed between the razor cartridge 16 and the reservoir 14 and is mounted such that it is moveable relative to both the razor cartridge and the reservoir such that pivotal movement of the razor cartridge relative to the reservoir causes movement of the linkage relative to both the razor cartridge and the reservoir. Preferably a first end 52 of the linkage is pivotally supported by the reservoir and an opposed second end 54 of the linkage includes a cam follower 56 in sliding contact with the cam surface 26 of the razor cartridge. The linkage includes a plug 58. When the razor cartridge is in its at-rest position as depicted in FIG. 1 the plug 58 blocks or otherwise seals the vent 34 of the reservoir. Elastomeric seal 36 is provided to accommodate any slight misalignment between the plug and the vent caused e.g. by manufacturing tolerances to ensure acceptable vent sealing is achieved. Plug 58 can also comprise an elastomeric material.

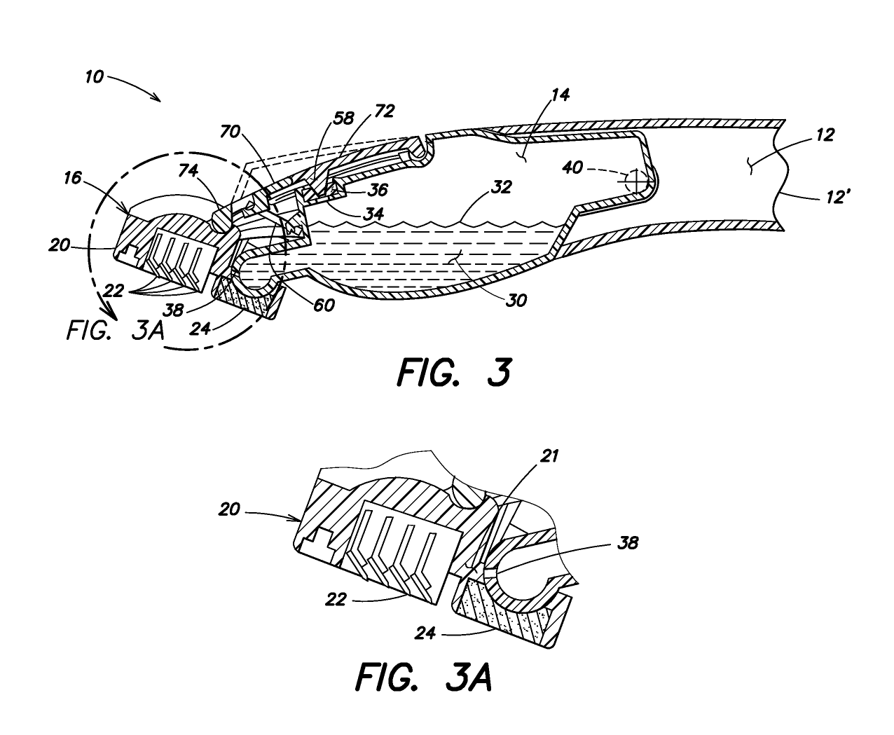

The linkage can alternatively comprise more than one member, for example two members 70, 72 hingedly connected as depicted in FIG. 3. Pivotal movement of the razor cartridge relative to the reservoir causes an angle between the hinged members to change, as shown by the dashed lines in FIG. 3. In this embodiment the second end 74 of the linkage can be pivotally supported by the housing of the razor cartridge.

Referring now to FIG. 2, when the razor cartridge pivots away from its at-rest position relative to the handle under the influence of forces encountered during normal use, the cam follower 56 of the linkage 50 is caused to slide along cam surface 26. The linkage 50 moves relative to the reservoir by pivoting about first end 52 causing plug 58 to be at least partially removed from the vent 34 of the reservoir providing pressure relief for any partial vacuum in the reservoir.

A biasing member 60 is provided. Preferably the biasing member extends between elements 62, 64 of the linkage and the reservoir respectively and comprises a tension-exerting element such as an extension spring or an elastomeric strip or band. The biasing member acts to urge the linkage to its position where the plug blocks or seals the vent as depicted in FIG. 1. One of skill in the art will understand that other biasing members may be provided in the alternative or in addition to the biasing member described above. For example a torsion spring can be provided at the first end of the linkage to urge the linkage to the described position. Alternatively a compression spring or leaf spring can be provided between the handle and the linkage. The biasing member also acts to urge the razor cartridge to its at-rest position via the cam follower of the linkage acting on the cam surface of the housing of the razor cartridge.

Between periods of use the effect of the biasing member will urge the razor cartridge to its at-rest position. The plug of the linkage will block or seal the vent of the reservoir. Unwanted flow or drooling of the shaving aid material out of the reservoir through the port 38 and applicator 24 and onto e.g. a bathroom counter surface is resisted as the plug seals the reservoir and any such flow would create a partial vacuum in the reservoir. During use of the safety razor the shaving aid material will be deposited on the skin surface of the user from the applicator and the oleophilic nature of the applicator will cause flow of the shaving aid material from the reservoir to the applicator. This can in turn create a partial vacuum in the reservoir which can throttle the flow of shaving aid material. However during normal use the razor cartridge can pivot away from its at-rest position in response to forces encountered. The plug will be partially removed from the vent relieving any such partial vacuum to ensure the flow rate of the shaving aid material is not thereby throttled.

While various embodiments have been described above, it should be understood that they have been presented by way of example only, and not limitation. For instance, modifications or changes as can be made within the scope of the attached claims and features disclosed in connection with any one embodiment can be used alone or in combination with each feature of the respective other embodiments. Thus, the breadth and scope of any embodiment should not be limited by any of the above described exemplary embodiments, but should be defined only in accordance with the following claims and their equivalents.

What is claimed is:

1. A safety razor, comprising:
a handle adapted to pivotally support a razor cartridge;
a biasing member;
a reservoir adapted to contain a portion of a non-solid shaving aid material, at least partially disposed in the handle, the reservoir including a vent extending through a wall of the reservoir;
a razor cartridge pivotally mounted to the handle and adapted to pivot away from an at-rest position relative to the handle in response to forces encountered during normal use of the safety razor against forces provided by the biasing member to bias the cartridge towards the at-rest position; wherein the razor cartridge is further pivotally coupled to the reservoir; and
a linkage extending between the razor cartridge and the reservoir, the linkage having a plug arranged to block the vent when the razor cartridge is in the at-rest position;
wherein when the razor cartridge pivots away from the at-rest position in response to forces encountered during normal use of the safety razor, pivotal movement of the razor cartridge relative to the reservoir causes further movement of the linkage relative to both the razor cartridge and the reservoir and causes the plug to be at least partially removed from the vent.

2. The safety razor of claim 1, wherein the reservoir contains the portion of the non-solid shaving aid material and wherein the shaving aid material defines a level during normal use of the safety razor.

3. The safety razor of claim 1, wherein the vent is disposed in the wall of the reservoir in a region of the reservoir away from the shaving aid material.

4. The safety razor of claim 1, wherein the reservoir is slidable along the handle.

5. The safety razor of claim 1, wherein the biasing member is disposed between the reservoir and the linkage.

6. The safety razor of claim 1, wherein the vent includes an elastomeric seal.

7. The safety razor of claim 1, wherein the plug comprises an elastomeric material.

8. The safety razor of claim 1, wherein the reservoir includes at least one port adapted to provide fluid communication between the reservoir and an applicator of the razor cartridge.

9. The safety razor of claim 8, wherein the port is closed when the razor cartridge is in the at-rest position.

10. The safety razor of claim 1, wherein the razor cartridge adapted to pivot away from the at-rest position in a single direction in response to forces encountered during normal use of the safety razor.

11. The safety razor of claim 1, wherein the razor cartridge comprises a housing having a cam surface.

12. The safety razor of claim 11, wherein the linkage is pivotally supported by the reservoir at a first end and has a cam follower at an opposed second end in slidable contact with the cam surface of the razor cartridge.

13. The safety razor of claim 12, wherein when the razor cartridge pivots away from the at-rest position in response to forces encountered during normal use of the safety razor the cam follower slides along the cam surface.

14. The safety razor of claim 1, wherein the linkage comprises at least one member.
